(19) United States
(12) Patent Application Publication
(10) Pub. No.: US 2002/0008617 A1
(43) Pub. Date: Jan. 24, 2002

(54) Flashing rescue signal light unit

(76) Inventor: Wen I Auguste Lee, Fullerton, CA (US)

Correspondence Address: David and Raymond Patent Group, 1050 Oakdale Lane, Arcadia, CA, 91006, US

(21) Appl. No.: 09/854,062

(22) Filed: May 12, 2001

Related U.S. Application Data
(60) Provisional application No. 60/203,842, filed on May 12, 2000.

(51) Int. Cl. B60Q 1/26

(52) U.S. Cl. 340/468; 340/471

(57) ABSTRACT

A flashing rescue signal light unit includes a plurality of illuminating units each including a casing, an illuminator protected by the casing, and an electric input connector provided on the casing and electrically connected with the illuminator, and a power supply device electrically connected between the illuminating units and a power source of a vehicle, wherein each of the illuminating units is shaped as an alphabet in such a manner the visibility of such alphabet is highly increased through the illuminating unit. Accordingly, the flashing rescue signal light unit is adapted for installing into the existing vehicle, which enables the user to customize the array of alphabet to form a rescue signal for strongly indicating the rescue signal when the driver is in danger and needs help.

### CROSS REFERENCE RELATED TO THE APPLICATION

This is a regular application of a provisional application, Ser. No. 60/203,842, filed May 12, 2000.

### BACKGROUND OF THE PRESENT INVENTION

1. Field of Invention

The present invention relates to signal light unit, and more particularly to a flashing rescue signal light unit which adapted for strongly signifying the driver is in danger and needs help, so as highly increase the liability of driving.

2. Description of Related Arts

Thousands of accidents occur everyday because of the drivers' careless. Accidents usually occur especially when drivers want to cut lane on the road without a significant signal so that collisions may happen between vehicles. Moreover, when the driver is in danger such as being chased or the vehicle suddenly broken down on the freeway or the street, an emergency light on the vehicle should be significantly switched on to awake people in the surroundings. So, a panel of signlight such as turn and hazard warning signlight is important to a vehicle for attracting people's attention by the designated signals.

A conventional vehicle signlight system is usually installed at a rear panel of a vehicle in which the vehicle signlight system comprises a pair of hazard warning lights each having a yellow illuminator, which are twinkled at two outermost ends of the rear panel respectively.

Since the conventional vehicle signlight system is installed at the lower portion of the vehicle which is the rear panel of the vehicle, other drivers may hard to aware of the immediate signal especially at some conditions such as in rainy day or winding road. Furthermore, the hazard warning lights flashing at two ends of the rear panel are not shape enough for people to recognize the emergency of the driver especially when the hazard warning lights are hidden by other vehicle. Worse, driver does not have other alternative method but the hazard warning light for signifying he or she is in danger while people will just think the vehicle is broken down.

### SUMMARY OF THE PRESENT INVENTION

The main object of the present invention is to provide a flashing rescue signal light unit which is adapted for strongly signifying the driver is in danger and needs help, so as to highly increase the liability of driving.

Another object of the present invention is to provide a flashing rescue signal light unit which is easy to install to an existing vehicle and in low cost.

Another object of the present invention is to provide a flashing rescue signal light unit which is reliable and highly effective strobe product to a vehicle.

Another object of the present invention is to provide a flashing rescue signal light unit which can be equipped with an existing vehicle without any alteration of the vehicle.

Accordingly, in order to accomplish the above objects, the present invention provides a flashing rescue signal light unit, comprising:

a plurality of illuminating units, each of which is shaped into a specific character each comprising a casing, an illuminator protected by the casing, and an electric input connector provided on the casing and electrically connected with the illuminator, and

a power supply device electrically connected between the illuminating units and a power source of a vehicle.

In an alternative embodiment, the present invention provides a flashing rescue signal light unit, comprising:

a plurality of illuminating units, each of which is shaped into a specific character each comprising a casing, an illuminator protected by the casing, and an electrical terminal provided on the casing and electrically connected with the illuminator,

an electric adapter detachably engaged with the electrical terminals of the illuminating units for electrically connecting between the illuminating units, and

a power supply device electrically connected between the illuminating units and a power supply of a vehicle.

### BRIEF DESCRIPTION OF THE DRAWINGS

FIG. 1 is a perspective view of a flashing rescue signal light unit according to a first preferred embodiment of the present invention.

FIG. 2 is a perspective view of the flashing rescue signal light unit according to the above first preferred embodiment of the present invention, illustrating the illuminating units being installed into a side mirror housing of a vehicle.

FIG. 3 illustrates an alternative mode of the flashing rescue signal light unit according to the above first preferred embodiment of the present invention.

FIG. 4 a rear perspective view of the flashing rescue signal light unit installed into a vehicle according to the above first preferred embodiment of the present invention.

FIG. 5 is a rear perspective view of a flashing rescue signal light unit according to a second preferred embodiment of the present invention.

FIG. 6 illustrates an alternative mode of the electric adapter of the flashing rescue signal light according to the above second preferred embodiment of the present invention.

### DETAILED DESCRIPTION OF THE PREFERRED EMBODIMENT

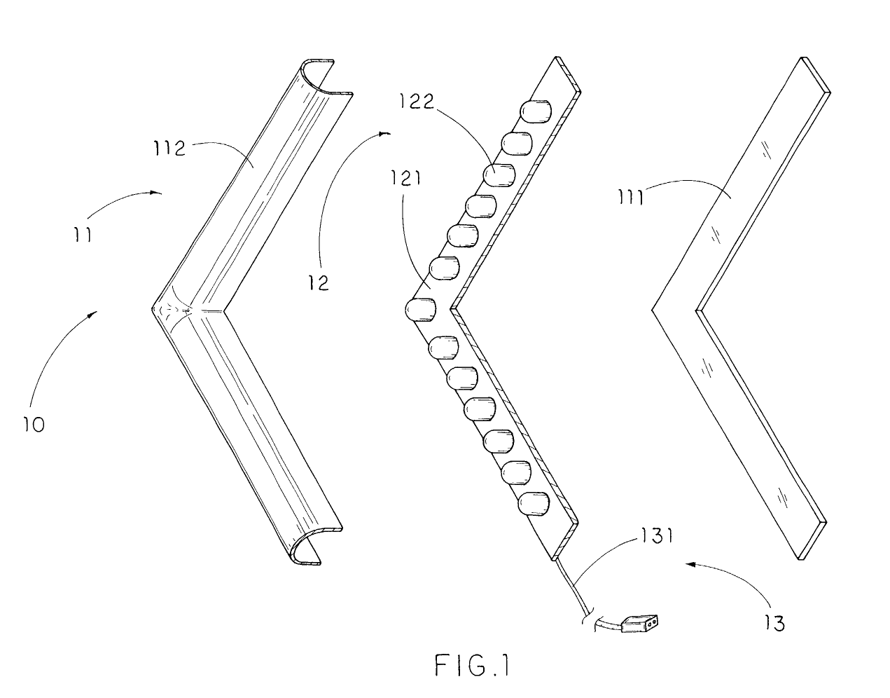

Referring to FIG. 1 of the drawing, a flashing rescue signal light unit 1 according to a first preferred embodiment of the present invention is illustrated, wherein the flashing signal light unit 1 is adapted for installing into an existing vehicle such as a tail light and a rear windshield of the existing vehicle.

When flashing signal light unit 1 is electrically connected with the existing vehicle, the flashing signal unit 1 is adapted to function as an auxiliary signlight for signifying the rescue signal of the driver clearly. Alternatively, the flashing signal unit 1 can also be built in the existing vehicle as an auxiliary signlight.

The flashing signal light unit 1 comprises a plurality of illuminating units 10, each of which is shaped into a specific character, each comprising a casing 11, an illuminator 12 protected by the casing 11, and an electric input connector 13 provided on the casing 11 and electrically connected with the illuminator 12. Each of the plurality of the illuminating units 10 is shaped into a specific character, such as an alphabet (A to Z). The flashing signal light unit 1 further comprises a power supply device 30 electrically connected between the illuminating units 10 and a power supply 2 of a vehicle.

The casing 11 of each illuminating unit 10 comprises a protective layer 111 and a shelter 112 having a character shape, such as alphabet, and a transparent front surface. The shelter 112 is made of transparent and waterproof material such as material. As shown in FIG. 1, the shelter 112 of the casing 11 is shaped as a V shape and has a U-shaped cross section. The protective layer 111 is also shaped as the character respective to the shelter 112 wherein the shelter 112 is sealedly attached to the protective layer 111 to define a lighting chamber 113 therebetween to receive the illuminator 12 therein. Accordingly, the protective layer 111 is made of resin such that the illuminator 12 is well protected by the casing 11 in such a water tight manner.

The illuminator 12 comprises a circuit board 121 sealedly mounted on the protective layer 111 and covered by the shelter 112 in a water tight manner, and a plurality of LEDs 122 electrically connected on the circuit board 121 in such a manner the LEDs 122 are spacedly aligned and affixed on the circuit board 121. The circuit board 121 of the illuminator 12 is also shaped corresponding to the casing 11 having the character shape, such as the V shape, such that the illuminator 12 is fittingly received in the casing 11. In other words, the entire illuminating unit 10 is in a character shape such as “V” as shown in FIG. 1. Moreover, since the shelter 112 of the casing 11 is made of transparent material, the lightened LEDs 122 can be viewed from outside.

The electric input connector 13 comprises an electric cable 131 provided on a back of the casing 11 is electrically connected to the circuit board 121. The power supply device 30 comprises an electric cord 31 electrically connecting with the electric cable 131 of the electric input connector 13 to a power plug 32 which is extended to a power source of the vehicle such as a battery of the vehicle.

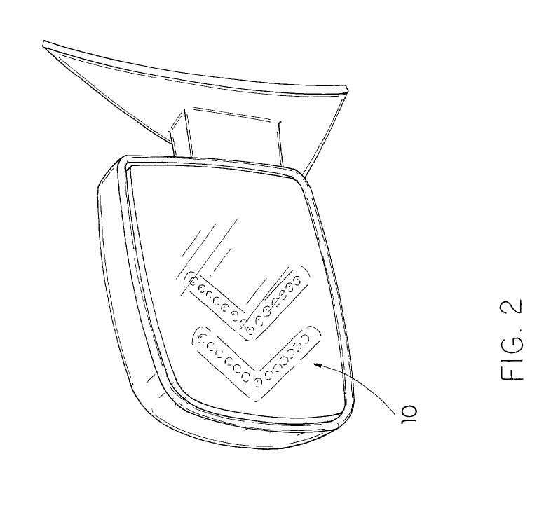

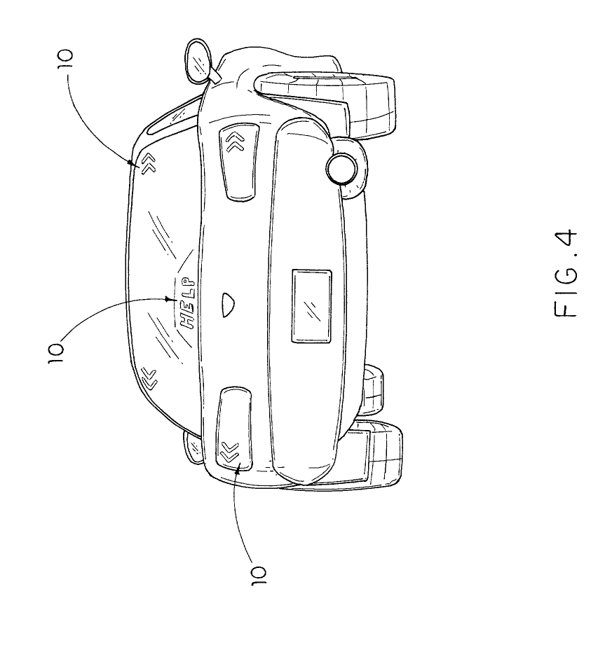

As shown in FIG. 2, the illuminating units 10 are adapted to be installed into a side mirror housing of the vehicle such as an interior surface of a side mirror wherein the illuminating units 10 are aligned and shaped as an arrowhead shape for providing a rescue signal to notice people in the surrounding. Since the side mirror of the vehicle is a one-way mirror such that when the illuminating units 10 are switched off, the illuminating units 10 cannot be seen from outside. While the illuminating units 10 are switched on, the light from the illuminating units 10 is adapted to pass through the side mirror for indicating the rescuer signal, so that the illuminating units 10 can keep the beauty appearance of the vehicle. Alternatively, the illuminating units 10 are attached on an interior surface of a rear windshield or/and a tail lamp of the vehicle, as shown in FIG. 4, such that people at the side and back view of the vehicle can be notify clearly while the illuminating units 10 are switched on.

For example, when the vehicle is broken down on the street, the driver will usually turn on a hazard warning light for indicating the emergency signal for other drivers. However, the flashing hazard warning light of the vehicle may not notify clear enough the moving direction of the other vehicles in order to avoid accident occurs. So, when the driver switches on the illuminating units 10, the flashing illuminating units 10 will detour other drivers to change lane, so as to prevent an avoidable collision of the vehicle. In other words, the illuminating units 10 are similar to a re-directional signal sign or as a detour signal while a construction is working ahead as it is normally seen on the freeway.

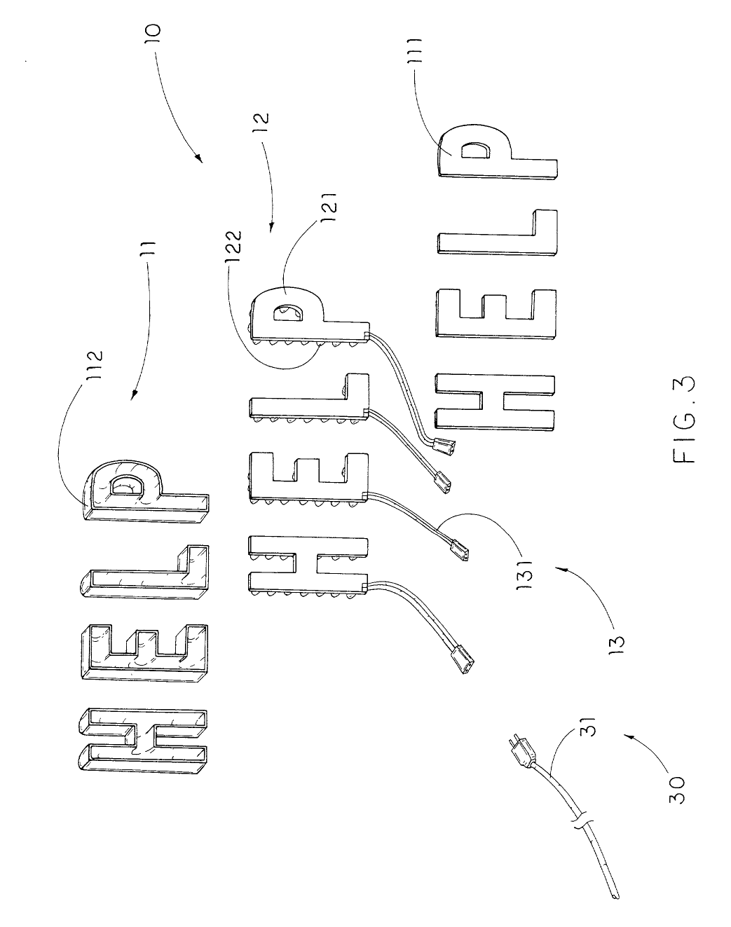

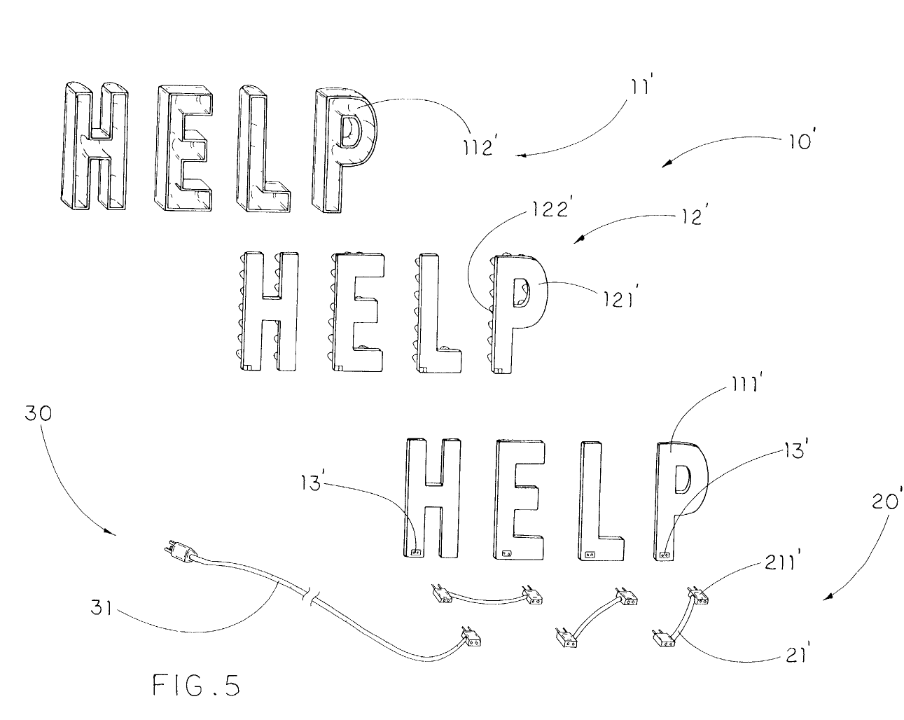

Alternatively, the illuminating unit 10 can also be shaped as an alphabet from A to Z, so that each of the illuminating units 10 is capable of representing a particular character. In other words, the illuminating units 10 are selectively aligned to form a combination of the alphabets in an array manner. As shown in FIG. 3, the illuminating units 10 are respectively shaped as H, E, L, and P and aligned to form a word of “HELP” as an emergency light wherein the illuminating units 10 are adapted for mounting on the interior surface of the rear windshield, as shown in FIG. 5, such that when the illuminating units 10 is switched on, the rescue massage from the illuminating units 10 is adapted for noticing the emergency signal to the people at the back of the vehicle that the driver is in emergency and needs help. Moreover, the illuminating units 10 can be shaped as another common rescue signal such as “SOS” that can be easily recognized by the people. It is worth to mention that the illuminating units 10 are flashing when they are switched on so as to easily get the attention from other people for strong signifying the driver is in danger and needs help.

The power device 30 may further comprises a power control for turning on the illuminating units 10 wherein the power control can be a switch installed at a designated places inside the vehicle such as the dashboard or armrest for easy reaching and/or can be a remote control, so that the driver and passengers are able to turn on the illuminating units 10 immediately when necessary.

Referring to FIG. 5 of the drawing, the flashing rescue signal light unit 1′ according to a second embodiment of the present invention is illustrated, wherein an electric terminal 13′ provided on the casing 11′ and electrically connected with the illuminator 12′ and an electric adapter 20′ adapted to engage with the electric terminal 13′ for electrically connecting between the illuminating units 10′.

The electric terminal 13′ of each illuminating unit 10′ is electrically connected to the circuit board 121′ of the illuminator 12′ and is provided on the casing 11′ at the protective layer 111′ thereof.

The electric adapter 20′ according to the second preferred embodiment is a conductive wire 21′ having two power connectors 211′ provided at two ends thereof wherein each power connector 211′ is adapted to engage with the electric terminal 13′ of the illuminating unit 10′ for electrically connecting two illuminating units 10′ together. Thus, the electric cord 31′ of the power supply device 30′ is electrically connected with the electric adapter 20′ and extended to the power source to the vehicle for electrically connecting with each illuminating unit 10′. In other words, the illuminating units 10′ are electrically connected with each other as a serial connection.

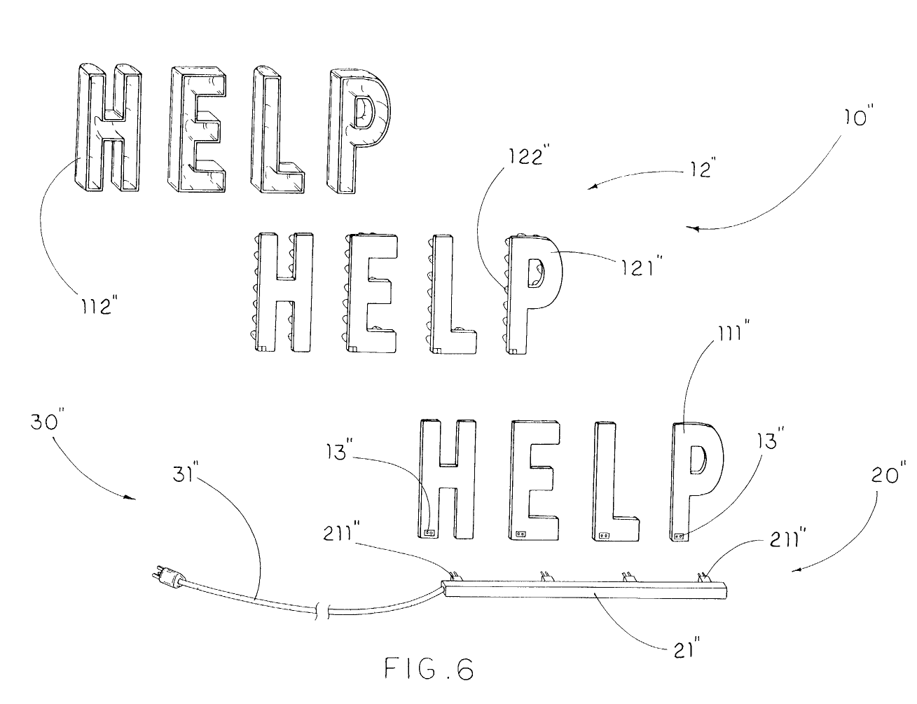

As shown in FIG. 6, an alternative mode of the electric adapter 20″ according to the second embodiment is illustrated, wherein the electric adapter 20″ having a rigid supporting frame 21″ comprises a plurality of power connectors 211″ aligned thereon such that the electric terminals 13″ of the illuminating unit 10″ are adapted to engage with the power connectors 211″ respectively in such a manner the illuminating units 10″ are lined-up along the electric adapter 20″. The advantage of the electric adapter 20″ is that the electric adapter 20″ can rigidly support the illuminating units 10″ thereon in order to avoid unwanted lateral movement of the illuminating units 10″.

What is claimed is:

1. A flashing rescue signal light unit, comprising
a plurality of illuminating units, each of which is shaped into a specific character each comprising a casing, an illuminator protected by the casing, and an electric input connector provided on the casing and electrically connected with the illuminator, and
a power supply device electrically connected between the illuminating units and a power source of a vehicle,
wherein said illuminating units are adapted for mounting on said vehicle in such a manner when said illuminating units are switched on, said illuminating units are flashing in order to strongly signify a rescue signal to people in the surrounding.

2. A flashing rescue signal light unit, as recited in claim 1, wherein said illuminating units are shaped as alphabets.

3. A flashing rescue signal light unit, as recited in claim 1, wherein said casing of said illuminating unit comprises a protective layer and a shelter having a transparent front surface, wherein said shelter is sealedly attached to said protective layer to define a lighting chamber therebetween to receive said illuminator therein.

4. A flashing rescue signal light unit, as recited in claim 2, wherein said casing of said illuminating unit comprises a protective layer and a shelter having a transparent front surface, wherein said shelter is sealedly attached to said protective layer to define a lighting chamber therebetween to receive said illuminator therein.

5. A flashing rescue signal light unit, as recited in claim 3, wherein said illuminator comprises a circuit board sealedly mounted on said protective layer and covered by said shelter in a water tight manner, and a plurality of LEDs electrically connected on said circuit board in such a manner said LEDs are spacedly aligned and affixed on said circuit board.

6. A flashing rescue signal light unit, as recited in claim 5, wherein said electric input connector comprises an electric cable provided on a back of said casing and electrically connected to said circuit board, wherein said power supply device comprises an electric cord electrically connecting with said electric cable of said electric input connector to a power plug which is extended to a power source of said vehicle.

7. A flashing rescue signal light unit, as recited in claim 6, wherein said power supply device further comprises a power control having at least a switch mounted in said vehicle for controlling said illuminating units on and off.

8. A flashing rescue signal light unit, as recited in claim 7, wherein said illuminating units are adapted for installing into a side mirror housing of said vehicle.

9. A flashing rescue signal light unit, as recited in claim 7, wherein said illuminating units are adapted for installing into a tail light of said vehicle.

10. A flashing rescue signal light unit, as recited in claim 7, wherein said illuminating units are adapted for installing into an interior surface of a rear windshield of said vehicle.

11. A flashing rescue signal light unit, comprising
a plurality of illuminating units, each of which is shaped into a specific character each comprising a casing, an illuminator protected by the casing, and an electrical terminal provided on the casing and electrically connected with the illuminator,
an electric adapter detachably engaged with said electrical terminals of said illuminating units for electrically connecting between said illuminating units, and
a power supply device electrically connected between the illuminating units and a power source of a vehicle,
wherein said illuminating units are adapted for mounting on said vehicle in such a manner when said illuminating units are switched on, said illuminating units are flashing in order to strongly signify a rescue signal to people in the surrounding.

12. A flashing rescue signal light unit, as recited in claim 11, wherein said illuminating units are shaped as alphabets.

13. A flashing rescue signal light unit, as recited in claim 12, wherein said casing of said illuminating unit comprises a protective layer and a shelter having a transparent front surface, wherein said shelter is sealedly attached to said protective layer to define a lighting chamber therebetween to receive said illuminator therein.

14. A flashing rescue signal light unit, as recited in claim 13, wherein said illuminator comprises a circuit board sealedly mounted on said protective layer and covered by said shelter in a water tight manner, and a plurality of LEDs electrically connected on said circuit board in such a manner said LEDs are spacedly aligned and affixed on said circuit board.

15. A flashing rescue signal light unit, as recited in claim 14, wherein said electric adapter is a conductive wire having two power connectors adapted to engage with said electric terminal of said illuminating unit for electrically connecting said two illuminating units together, and wherein said power supply device comprises an electric cord electrically connecting with said electric adapter to a power plug which is extended to a power source of said vehicle.

16. A flashing rescue signal light unit, as recited in claim 15, wherein said power supply device further comprises a power control having at least a switch mounted in said vehicle for controlling said illuminating units on and off.

17. A flashing rescue signal light unit, as recited in claim 16, wherein said illuminating units are adapted for installing into an interior surface of a rear windshield of said vehicle.

18. A flashing rescue signal light unit, as recited in claim 14, wherein said electric adapter comprises a rigid supporting frame having a plurality of power connector aligned thereon for electrically engaging with said electric terminals, and wherein said power supply device comprises an electric cord electrically connecting with said electric adapter to a power plug which is extended to a power source of said vehicle.

19. A flashing rescue signal light unit, as recited in claim 18, wherein said power supply device further comprises a power control having at least a switch mounted in said vehicle for controlling said illuminating units on and off.

20. A flashing rescue signal light unit, as recited in claim 19, wherein said illuminating units are adapted for installing into an interior surface of a rear windshield of said vehicle.
